(19) United States
(12) Patent Application Publication
(10) Pub. No.: US 2012/0254037 A1
(43) Pub. Date: Oct. 4, 2012

(54) CARDS, DEVICES, SYSTEMS, AND METHODS FOR PAYMENT FUNCTIONALITY SELECTION

(76) Inventor: Jeffrey D. Mullen, Pittsburgh, PA (US)

(21) Appl. No.: 13/437,760

(22) Filed: Apr. 2, 2012

Related U.S. Application Data
(60) Provisional application No. 61/471,246, filed on Apr. 4, 2011.
(60) Provisional application No. 61/514,871, filed on Aug. 3, 2011.

(51) Int. Cl. G06Q 40/00

(52) U.S. Cl. 705/44; 705/39

(57) ABSTRACT

A user is provided with a GUI that may allow the user to change functionality associated with a non-battery-powered card, a battery-powered card, a payment sticker, or another device (e.g., a mobile telephonic device). The GUI may be provided on, for example, a display screen of a device (e.g., mobile telephonic device or tablet computer) as an application for that device. The GUI may be provided by a website so that a user views the GUI from a web-browser. At any time, for example, a user may change additional functionality performed at payment. A user may change the additional functionality for a card or a button of a card. In this manner, a user may change that a button on a powered card performs a check-in operation for a check-in service to receives a coupon, if a coupon is available for that transaction, from the a coupon-service.

### CROSS-REFERENCE TO RELATED APPLICATION

This application claims the benefit of U.S. Provisional Patent Application Nos. 61/471,246, titled “CARDS, DEVICES, SYSTEMS, AND METHODS FOR PAYMENT FUNCTIONALITY SELECTION,” filed Apr. 4, 2011 (Attorney Docket No. D/062 PROV), and 61/514,871, titled “CARDS, DEVICES, SYSTEMS, AND METHODS FOR ADVANCED PAYMENT FUNCTIONALITY SELECTION,” filed Aug. 3, 2011 (Attorney Docket No. D/072 PROV) all of which are hereby incorporated by reference herein in their entirety.

### BACKGROUND OF THE INVENTION

This invention relates to magnetic cards and devices and associated payment systems.

### SUMMARY OF THE INVENTION

Systems and methods are provided for allowing a user to select an additional service to be performed in addition to the payment of goods with a payment card or other device (e.g., a mobile telephonic device, a tablet computer device, or another electronic device). A card, or other device, may include one or more buttons. A user may associate an additional service to a button of a card at any time. At the time of purchase, information indicative of the button the user selected may be passed to a point-of-sale system with a user's payment information. Such data may be, for example, communicated through a merchant acquirer's network to a processing facility. The processing facility may, for example, authorize a payment transaction and forward the information indicative of the button a user selected and the identity of a user to a remote facility. Such a remote facility may, for example, forward at least some of such information, as well as additional information, to a third party service provider such that the third party service provider enacts the additional feature desired by the user.

Such an additional feature may include, for example, a game action in an online game by a game service provider, a check-in to a location by a check-in service provider, redeem a coupon or voucher by a third party coupon provider, earn loyalty points by a third party loyalty service, rate a transaction or location by a rating service, any combination of such features, or any additional feature.

Selection of a feature may be provided, for example, by a Graphical User Interface (GUI) provided on a computing device (e.g., a mobile telephonic device) as a software application for that device or via the internet or an intranet through a web browser. Such a selection may be provided with a non-powered card such that a single feature may be associated with a card for a period of time. Such a selection may be associated to an option (e.g., a button) on a powered card or other device (e.g., a mobile telephonic device) such that the user may associate different features with different options (e.g., different buttons). Accordingly, for example, a user may receive a powered card, or other device, in the mail and use his/her web browser to associate different additional features to different buttons. The user may then utilize the card in a store and press a button in order to select that feature. A card, or other device, may download information (e.g., via a wireless communication such as a light or electromagnetic communication) such that the card, or other device, displays information next to an option indicative of the feature (e.g., “Redeem LivingSocial Voucher,” “Facebook Like”). Alternatively, no download may be provided and no additional information may be display may be provided such that a user's card, or other device, includes a generic descriptor (e.g., “credit” and “feature,” or “feature 1” and “feature 2,” or “debit” and “feature 1” and “feature 2”).

A remote facility may also receive additional information than just a user identifier and information indicative of the option selected by a user (or that the user made a payment). Such additional information may be, for example, the type of merchant (e.g., a retail merchant or a gas merchant), the location of a merchant (e.g., the zip code of a merchant), the type of transaction (e.g., online or in-store purchase), the name of the merchant (e.g., “Amazon.com,” or “Walmart”), the amount of the transaction (e.g., $10.25), and any other information. Such a remote facility may forward such information to a third party service provider in addition to information generated by the remote facility (e.g., a second user identifier such that different identifiers are used with the facility sending payment information and the third party service provider).

An ecosystem may be provided in which a development kit is available for third parties to develop applications for payment cards or other devices. A GUI may be provided where a user can select different third party applications to be associated with a user's payment. The third party applications may need to be approved by an administrator before being accessible by a GUI. Different categories of third party applications may be provided on the GUI (e.g., a coupon category, a check-in category, a games category, a financial management tools category). The development kit may provide the ability for a third party service provider to, for example, receive user identification numbers and other information (e.g., merchant name and location) and provide particular information back (e.g., within a period of time) to a remote facility.

Information received from a third party service provider may include, for example, information indicative that the user was properly identified and a service was performed (e.g., “check-in completed,” “information added to financial management service.”). Such information may be provided back to an issuing bank, processor, or other service provider such that the information may be displayed on a user's bill statement. Additional information may also be provided that may change the way a transaction is authorized or settled.

Additional information received from a third party may be utilized to change the way a transaction is authorized or settled. For example, a third party may provide a user with the ability to pre-purchase a voucher to a particular store (e.g., a particular barber in a particular zip code). A user may associate this third party service to a button on the user's card. A user may make a purchase at this barber multiple times during a year on the user's credit account. The user may, at one such purchase, press the button associated with the desire to use the third party service and redeem a voucher the user already purchased or acquired. Information indicative of the user's desire to utilize such a service may be communicated to a point-of-sale terminal via a communications device located on the card (e.g., a dynamic magnetic stripe communications device, an RFID antenna, an exposed IC chip (e.g., an EMV chip, or any other communications device). The transaction may be authorized using the user's payment account if, for example, the user has enough funds associated with that account (e.g., a credit or debit account). The third party service provider may then determine the user had a pre-paid voucher for the transaction and may return to the card issuer, processor, or other party information indicative that the user's bill is to be adjusted by the amount of the voucher. Before, or after, settlement occurs a user's bill may show a statement credit in the amount of the voucher. A remote facility may perform such a data exchange as well as any associated value exchange. For example, the remote facility may, for a fee (e.g., a percentage of a transaction or a fixed fee), provide value from the third party service provider to the card issuer or processor (e.g., via an ACH or other type of monetary transaction). Alternatively, for example, the remote facility may provide the desired value to the card issuer, processor, or other party and demand the associated value be paid to the remote facility by the third party service provider within a period of time (e.g., three days). Information provided by a third party service provider to a remote facility may include an identifier indicative of the third party service provider, an identifier indicative of the user, an identifier indicative of the type of service provided by the third party service provider, an identifier indicative of the transaction with which further action by the third party service provider is desired, an amount of a post-statement credit that is to be applied for a particular transaction, and amount of a post-settlement credit that is to be applied for a particular transaction, an amount of a pre-settlement credit that is to be applied for a particular transaction, an amount of a credit that is to be applied during an authorization, an additional fee that is supposed to be added to a statement for an additional service (e.g., a fee-based financial management tool service), and any other information desired by the third party service provider, processor, card issuer, remote facility, device provider, or any other entity (e.g., a card network).

Information indicative of a button press, or use of a card, that triggers a feature may be provided in a payment message utilized at authorization or at settlement. Furthermore, the service provider may return information in a period of time that permits actions to be performed pre-authorization or pre-settlement.

The payment actions may be determined, for example, via a user interaction with the card. Particularly, for example, a user may press a button on the card, from a group of buttons, that is associated with the third party feature. Such third party features may be unique from the features provided to the user via the third parties non-payment card or device services. Accordingly, a user may obtain the benefit of the whimsical and festive nature of a unique feature every time the user makes a payment. Information indicative of feature selection may be provided, for example, via an output device operable to be read by a card reader. For example, the feature may be provided by a dynamic magnetic stripe communications device, an RFID antenna, an exposed IC chip, or any other type of card reader. For online purchases, for example, a display may be provided on the card and a user selection may cause a particular number (e.g., a particular code) to be displayed on the card. Such a code may be entered into a text box on a website at checkout and may be representative of the user's desired feature. Accordingly, the feature may be communicated to a remote server such that the feature may be performed in the third party service on behalf of the user. The code may additional provide the benefits of a security code and may be entered with a payment card number (e.g., a credit or debit card number) at online or in-store checkout.

Rewards may be awarded based on the amount of a purchase. Such rewards may be associated with a third party service or a card issuer, device or card provider, or other entity. For example, an amount of game currency may be awarded by a game provider at every purchase instead of a card issuer providing an amount of points, miles, or cashback to a user. Alternatively, for example, a user may earn both rewards from a card issuer as well as rewards from a third party service provider. A user may select, via, for example, physical buttons on the card or virtual buttons on a capacitive-sensitive display of a mobile telephonic device, the type of feature the user desires. Multiple features may be provided from a particular third party service provider. For example, a game service provider may provide a feature associated with one game action and another feature associated with another game action.

A card may include a dynamic magnetic communications device. Such a dynamic magnetic communications device may take the form of a magnetic encoder or a magnetic emulator. A magnetic encoder may change the information located on a magnetic medium such that a magnetic stripe reader may read changed magnetic information from the magnetic medium. A magnetic emulator may generate electromagnetic fields that directly communicate data to a magnetic stripe reader. Such a magnetic emulator may communicate data serially to a read-head of the magnetic stripe reader.

All, or substantially all, of the front as well as the back of a card may be a display (e.g., bi-stable, non bi-stable, LCD, LED, or electrochromic display). Electrodes of a display may be coupled to one or more capacitive touch sensors such that a display may be provided as a touch-screen display. Any type of touch-screen display may be utilized. Such touch-screen displays may be operable of determining multiple points of touch. Accordingly, a barcode may be displayed across all, or substantially all, of a surface of a card. In doing so, computer vision equipment such as barcode readers may be less acceptable to errors in reading a displayed barcode.

A card may include a number of output devices to output dynamic information. For example, a card may include one or more RFIDs or IC chips to communicate to one or more RFID readers or IC chip readers, respectively. A card may include devices to receive information. For example, an RFID and IC chip may both receive information and communicate information to an RFID and IC chip reader, respectively. A device for receiving wireless information signals may be provided. A light sensing device or sound sensing device may be utilized to receive information wirelessly. A card may include a central processor that communicates data through one or more output devices simultaneously (e.g., an RFID, IC chip, and a dynamic magnetic stripe communications device). The central processor may receive information from one or more input devices simultaneously (e.g., an RFID, IC chip, dynamic magnetic stripe devices, light sensing device, and a sound sensing device). A processor may be coupled to surface contacts such that the processor may perform the processing capabilities of, for example, an EMV chip. The processor may be laminated over and not exposed such that such a processor is not exposed on the surface of the card.

A card may be provided with a button in which the activation of the button causes a code to be communicated through a dynamic magnetic stripe communications device (e.g., the subsequent time a read-head detector on the card detects a read-head). The code may be indicative of, for example, a feature (e.g., a payment feature). The code may be received by the card via manual input (e.g., onto buttons of the card) or via a wireless transmission (e.g., via light, electromagnetic communications, sound, or other wireless signals). A code may be communicated from a webpage (e.g., via light and/or sound) to a card. A card may include a display such that a received code may be visually displayed to a user. In doing so, the user may be provided with a way to select, and use, the code via both an in-store setting (e.g., via a magnetic stripe reader) or an online setting (e.g., by reading the code from a display and entering the code into a text box on a checkout page of an online purchase transaction). A remote server, such as a payment authorization server, may receive the code and may process a payment differently based on the code received. For example, a code may be a security code to authorize a purchase transaction. A code may provide a payment feature such that a purchase may be made with points, debit, credit, installment payments, or deferred payments via a single payment account number (e.g., a credit card number) to identify a user and a payment feature code to select the type of payment a user desires to utilize.

A dynamic magnetic stripe communications device may include a magnetic emulator that comprises an inductor (e.g., a coil). Current may be provided through this coil to create an electromagnetic field operable to communicate with the read-head of a magnetic stripe reader. The drive circuit may fluctuate the amount of current travelling through the coil such that a track of magnetic stripe data may be communicated to a read-head of a magnetic stripe reader. A switch (e.g., a transistor) may be provided to enable or disable the flow of current according to, for example, a frequency/double-frequency (F2F) encoding algorithm. In doing so, bits of data may be communicated.

Electronics may be embedded between two layers of a polymer (e.g., a PVC or non-PVC polymer). One or more liquid polymers may be provided between these two layers. The liquid polymer(s) may, for example, be hardened via a reaction between the polymers (or other material), temperature, or via light (e.g., an ultraviolet or blue spectrum light) such that the electronics become embedded between the two layers of the polymer and a card is formed.

A payment card or other device may receive information indicative of a feature desires to be added by a user. The payment card may communicate information indicative of the feature with payment card data associated with the card or a user selection. The payment data and feature information may be routed, for example, to an authorization server. The authorization server may authorize payment and, based on the authorized payment, communicate the feature information to a remote server. The remote server may utilize this remote information to impact a third party service. The feature information may, for example, be routed before the payment card data reaches an authorization server. At merchant settlement, charge backs may for a purchase associated with a game action may cause the feature to be reversed or a different feature to be implemented (e.g., a removal of rewards earned at authorization). The feature may be implemented at settlement upon confirmation that, for example, no chargeback was associated with the payment transaction.

### BRIEF DESCRIPTION OF THE DRAWINGS

The principles and advantages of the present invention can be more clearly understood from the following detailed description considered in conjunction with the following drawings, in which the same reference numerals denote the same structural elements throughout, and in which:

FIG. 1 is an illustration of a card and architecture constructed in accordance with the principles of the present invention;

FIG. 2 is an illustration of a card constructed in accordance with the principles of the present invention;

FIG. 3 is an illustration of a card constructed in accordance with the principles of the present invention;

FIG. 4 is an illustration of a card constructed in accordance with the principles of the present invention;

FIG. 5 is an illustration of a device constructed in accordance with the principles of the present invention;

FIG. 6 is an illustration of a device constructed in accordance with the principles of the present invention;

FIG. 7 is an illustration of a network constructed in accordance with the principles of the present invention;

FIG. 8 is an illustration of a graphical user interface constructed in accordance with the principles of the present invention;

FIG. 9 is an illustration of a graphical user interface constructed in accordance with the principles of the present invention;

FIG. 10 is an illustration of a graphical user interface constructed in accordance with the principles of the present invention;

FIG. 11 is an illustration of a graphical user interface constructed in accordance with the principles of the present invention;

FIG. 12 is an illustration of a process flow chart constructed in accordance with the principles of the present invention; and

FIG. 13 is an illustration of a graphical user interface and a device constructed in accordance with the principles of the present invention.

### DETAILED DESCRIPTION OF THE INVENTION

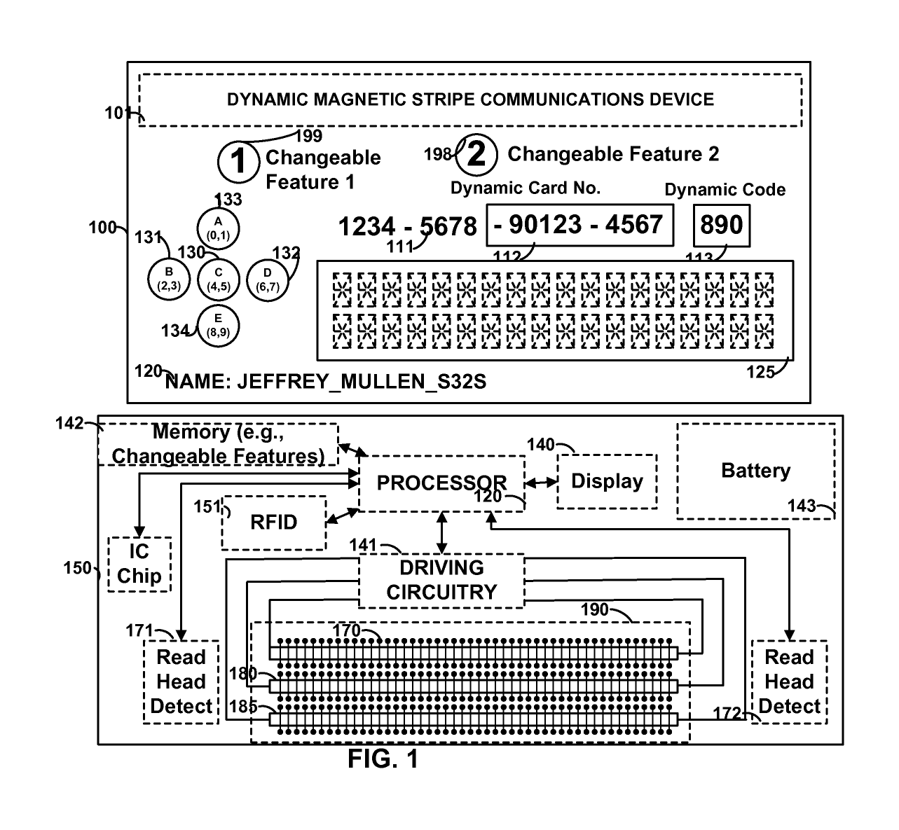

FIG. 1 shows card 100 that may include, for example, a dynamic number that may be entirely, or partially, displayed via display 112. A dynamic number may include a permanent portion such as, for example, permanent portion 111. Permanent portion 111 may be printed as well as embossed or laser etched on card 100. Multiple displays may be provided on a card. For example, display 113 may be utilized to display a dynamic code such as a dynamic security code. Display 125 may also be provided to display logos, barcodes, as well as multiple lines of information. A display may be a bi-stable display or non bi-stable display. Permanent information 120 may also be included and may include information such as information specific to a user (e.g., a user's name or username) or information specific to a card (e.g., a card issue date and/or a card expiration date). Card 100 may include one or more buttons such as buttons 131-134. Such buttons may be mechanical buttons, capacitive buttons, or a combination or mechanical and capacitive buttons. Card 100 may include button 199. Button 199 may be used, for example, to communicate information through dynamic magnetic stripe communications device 101 indicative of a user's desire to communicate a single track of magnetic stripe information. Persons skilled in the art will appreciate that pressing a button (e.g., button 199) may cause information to be communicated through device 101 when an associated read-head detector detects the presence of a read-head of a magnetic stripe reader. Button 198 may be utilized to communicate (e.g., after button 198 is pressed and after a read-head detects a read-head of a reader) information indicative of a user selection (e.g., to communicate two tracks of magnetic stripe data). Multiple buttons may be provided on a card and each button may be associated with a different user selections. Light sensor 127 may be provided, for example, to receive information from a display (e.g., a display of a mobile telephonic device or a laptop computer). Display 125 may allow a user to select (e.g., via buttons) options on the display that instruct the card to communicate (e.g., via a dynamic magnetic stripe communications device, RFID, or exposed IC chip) to use a debit account, credit account, pre-paid account, or point account for a payment transaction. Button 198 and button 199 may each be associated with, for example, a different third party service provider feature and may be changed by a user at any time. The third party feature associated with a button may be changed by a user on a GUI provided by a device provider, remote facility provider, card issuer, processor, or any other entity. For example, a third party service provider may, on its website or application, allow a user to change the third party feature performed when the third parties feature button is selected by a user on the user's card or other device. For example, suppose a third party service provider provides a check-in feature at particular stores and then presents the fact the user has checked into a location on a profile page of the user. One action may be to check-into the location using a payment transaction as the check-in. When a transaction is performed, a user's profile may be updated that the user has checked-into that location. Another action may be to check-into a particular transaction at as the check-in. When a transaction is performed, a user's profile may be updated that the user has made a purchase at the check-in. Another action a may be to check-into a particular product as the check-in. When a transaction is performed, a user's profile may be updated that the user has made a purchase of a particular item at the check-in. For example, a user may be provided with a GUI (e.g., on a mobile telephonic device of the user) when the user makes a purchase to identify the goods that the user has purchased. In doing so, features may be enhanced with additional information from a user after a purchase has been made.

The selection of a feature may or may not have a cost associated with it. If a cost is associated with the feature, for example, the cost may be added to a customer's statement (e.g., added to a credit or debit purchase) for a particular transaction. A fixed-fee or variable-fee (e.g., a percentage of the transaction) may then be removed from the fee charged to the user and distributed among particular parties (e.g., distributed among the card issuer and/or device provider). The remainder of the fee may be provided, for example, to the third party service provider. A cost may be associated to a feature selection, but may not be a cost to a user. Instead, for example, the cost may be a cost to a third party service provider. The cost may be provided, for example, to other entities such as, for example, the device provider, card issuer, card processor (which may be the same, for example, as the card issuer), or any other entity (e.g., card network).

Architecture 150 may be utilized with any card. Architecture 150 may include processor 120. Processor 120 may have on-board memory for storing information (e.g., drive code). Any number of components may communicate to processor 120 and/or receive communications from processor 120. For example, one or more displays (e.g., display 140) may be coupled to processor 120. Persons skilled in the art will appreciate that components may be placed between particular components and processor 120. For example, a display driver circuit may be coupled between display 140 and processor 120. Memory 142 may be coupled to processor 120. Memory 142 may include data, for example, that is unique to a particular card. Memory 142 may include any type of data. For example, memory 142 may store discretionary data codes associated with buttons of card 150. Such codes may be recognized by remote servers to effect particular actions. For example, a code may be stored on memory 142 that causes a third party service feature to be performed by a remote server (e.g., a remote server coupled to a third party service such as an online voucher or coupon provider). Different third party features may be associated with different buttons button. Or, for example, a user may scroll through a list of features on a display on the front of the card (e.g., using buttons to scroll through the list). A user may select the type of payment on card 100 via manual input interfaces corresponding to displayed options on display 125. Selected information may be communicated to a magnetic stripe reader via a dynamic magnetic stripe communications device. Selected information may also be communicated to a device (e.g., a mobile telephonic device) having a capacitive sensor or other type of touch sensitive sensor.

A Card may include, for example, any number of light sensors. Light sensors may be utilized such that a display screen, or other light emitting device, may communicate information to light sensors 127 via light.

Any number of reader communication devices may be included in architecture 150. For example, IC chip 150 may be included to communicate information to an IC chip reader. IC chip 150 may be, for example, an EMV chip. As per another example, RFID 150 may be included to communicate information to an RFID reader. A magnetic stripe communications device may also be included to communicate information to a magnetic stripe reader. Such a magnetic stripe communications device may provide electromagnetic signals to a magnetic stripe reader. Different electromagnetic signals may be communicated to a magnetic stripe reader to provide different tracks of data. For example, electromagnetic field generators 170, 180, and 185 may be included to communicate separate tracks of information to a magnetic stripe reader. Such electromagnetic field generators may include a coil wrapped around one or more materials (e.g., a soft-magnetic material and a non-magnetic material). Each electromagnetic field generator may communicate information serially to a receiver of a magnetic stripe reader for particular magnetic stripe track. Read-head detectors 171 and 172 may be utilized to sense the presence of a magnetic stripe reader (e.g., a read-head housing of a magnetic stripe reader). This sensed information may be communicated to processor 120 to cause processor 120 to communicate information serially from electromagnetic generators 170, 180, and 185 to magnetic stripe track receivers in a read-head housing of a magnetic stripe reader. Accordingly, a magnetic stripe communications device may change the information communicated to a magnetic stripe reader at any time. Processor 120 may, for example, communicate user-specific and card-specific information through RFID 151, IC chip 150, and electromagnetic generators 170, 180, and 185 to card readers coupled to remote information processing servers (e.g., purchase authorization servers). Driving circuitry 141 may be utilized by processor 120, for example, to control electromagnetic generators 170, 180, and 185.

Architecture 150 may also include, for example, a light sensor. Architecture 150 may receive information from a light sensor. Processor 120 may determine information received by a light sensor.

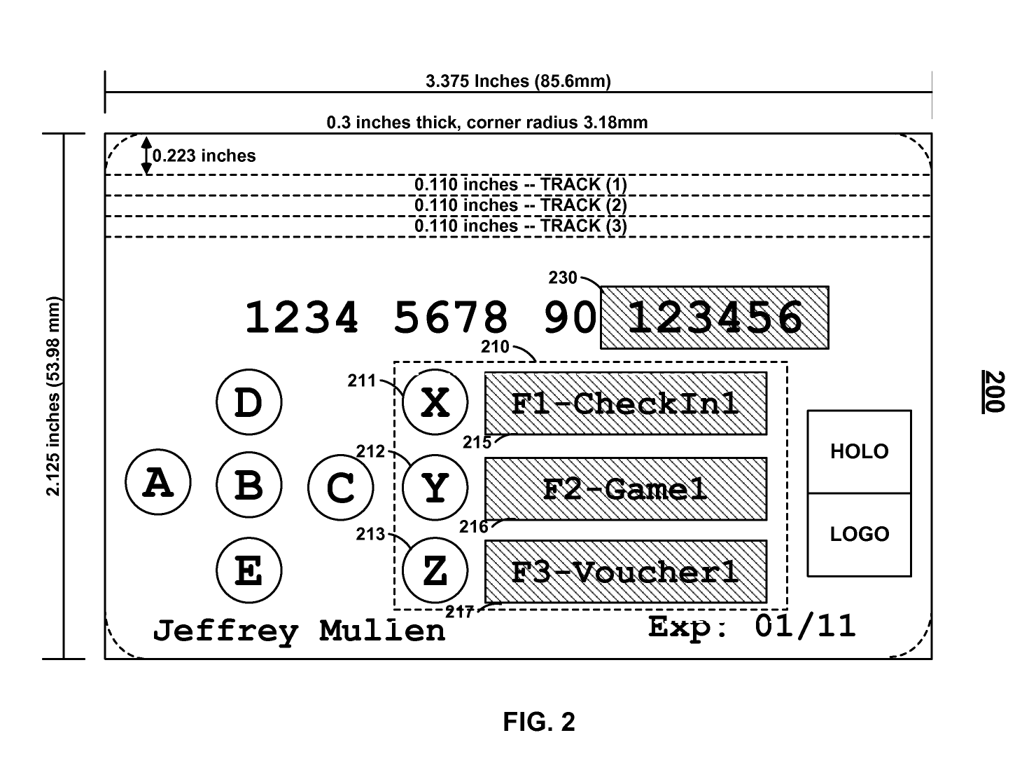

FIG. 2 shows card 200 that may include, for example, display 230 and interface 210. Interface 210 may include, for example, displays 215, 216, and 217 as well as buttons 211, 212, and 213. Display 215 may be associated with button 211. Display 215 may be associated with button 212. Display 217 may be associated with button 213. Display 230 may be utilized to display, for example, all or a portion of one or more payment card numbers such as a credit card number, debit card number, gift card number, pre-paid card number, loyalty card number, and/or any other card number. A card may be issued with a pre-determined set of actions associated with buttons 211-213. Such actions may correspond to actions that control a portion of a service from one or more third party service providers. A user may, at the time of applying for a payment card (or a payment service on another device such as a mobile telephonic device), select a particular card for a particular one or more third party services and also select the particular feature or features from the selected third party service or services for the card. Information associated with the third party service and feature for a button may be displayed on a display in the proximity of that button. Information associated with the game action for a button may also be permanently provided on the card in the proximity of a button. Such permanent indicia may take the form of printed indicia, embossed indicia, and/or engraved indicia. A user may change the game actions for particular buttons online (e.g., via a website associated with a card issuer or a game provider). Such a change may be implemented, for example, on backend systems. Accordingly, for example, a remote server may change the way it uses different messages received from the card. In doing so, a user may change features and third party services without having to change the operation of a card. Such a change may be implemented, for example, on the card. For example, a card may receive information wirelessly (e.g., via light and/or sound) indicative of a desire to change the game actions for a particular button. Accordingly, the card may reconfigure the uses of each button, display different information, and communicate different information when a particular button is selected. Such re-configuration instructions may be communicated manually to a card (e.g., via a code manually entered into buttons on the card). For example, each button of card 200 may be associated with a feature from a different third party service provider. A user may change feature preferences and, as a result, may want to add, remove, or modify a third party service provider feature. In reconfiguring the card or the backend, the user may, for example, add a feature for a third party service was released after card 200 was issued to the user.

Third party service features may take many forms. For example, an online video game may provide in-game actions. The same, or different actions, may be performed via a server receiving an instruction provided by a card to a card reader during a payment transaction. Particularly, information corresponding to a particular game action may be communicated by a card to a card reader. This information may be provided to a gaming server such that the game action may be implemented. Such a game action may be, for example, to perform a particular game action or earn a particular reward currency for that particular game.

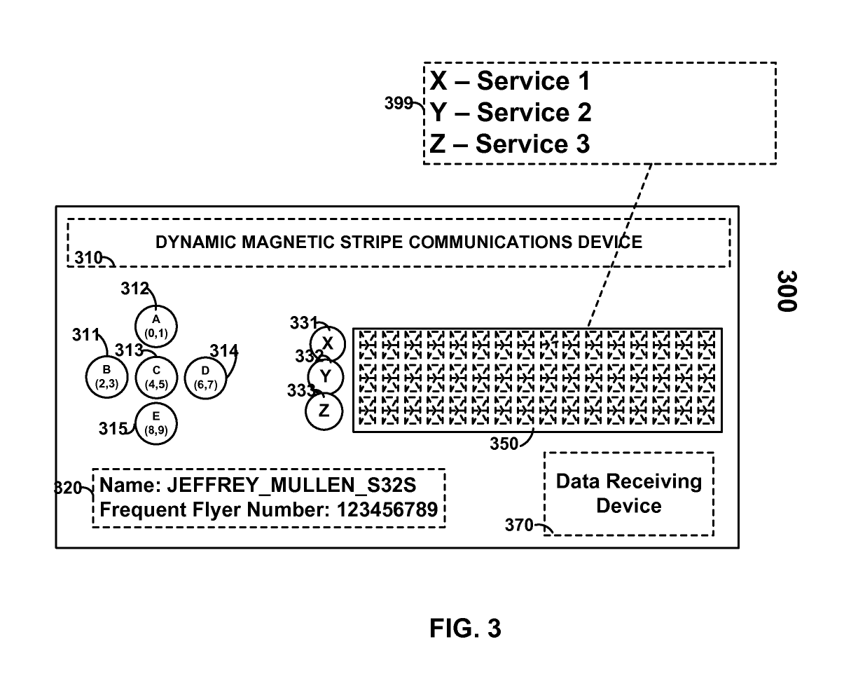

FIG. 3 shows card 300. Card 300 may include buttons 311-315, display 350, data receiving device 370, permanent information 320, and dynamic magnetic stripe communications device 310. Display 350 may include a graphical user interface such as interface 399. In graphical user interface 399, three options are provided. A user may select an option be selecting a button that corresponds to that option. Each option may be the ability for a user to use a different third party service provider feature a purchase. Each feature may be, for example, the ability for a user to earn a different third party reward such as a third party virtual currency. The amount of virtual currency earned may be, for example, a pre-determined amount or an amount based on a formula that includes, for example, the purchase amount. A user may change the virtual currency selections on a card at any time, for example, by entering a code or receiving information from device 370 (e.g., via light from an internet browser). Accordingly, as the habit of a user changes, the user may change his/her currency reward options for a card. Multiple virtual currency reward options may be associated with the same third party service. For example, one virtual currency reward option may be for a first game from a third party gaming service a different virtually currency reward option may be for a different game from that same third party gaming service.

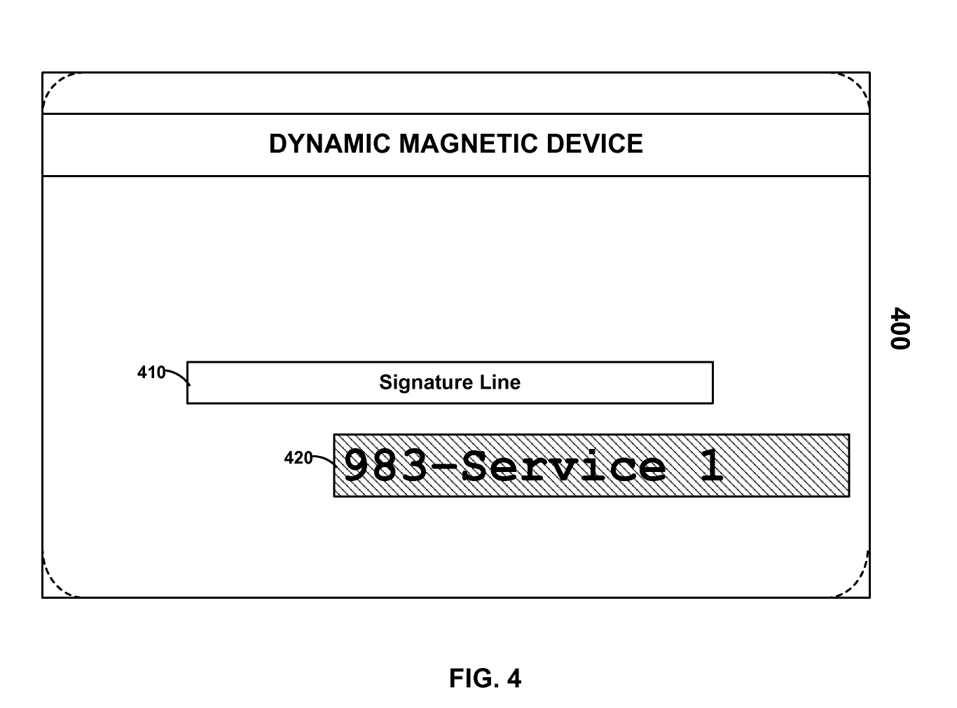

FIG. 4 shows card 400 that may include signature line 410 and display 420. A code may be provided on display 420 indicative of a particular third party service provider feature. The code may be entered as a security code for an online transaction. For example, a user may press a button associated with getting a third party service feature with his/her purchase. Such a button may be provided on the obverse side of a card. Similarly, a button may be provided on the reverse side of a card (e.g., the side of the card shown in card 400). The reverse side of the card may then display a security code that is indicative of the desire for a user to utilize a third party service feature with a purchase as well as be used to help authenticate the transaction. Accordingly, a user may obtain the benefits of third party service features while making online purchases via the use of dynamic security codes representative of security information and third party service features.

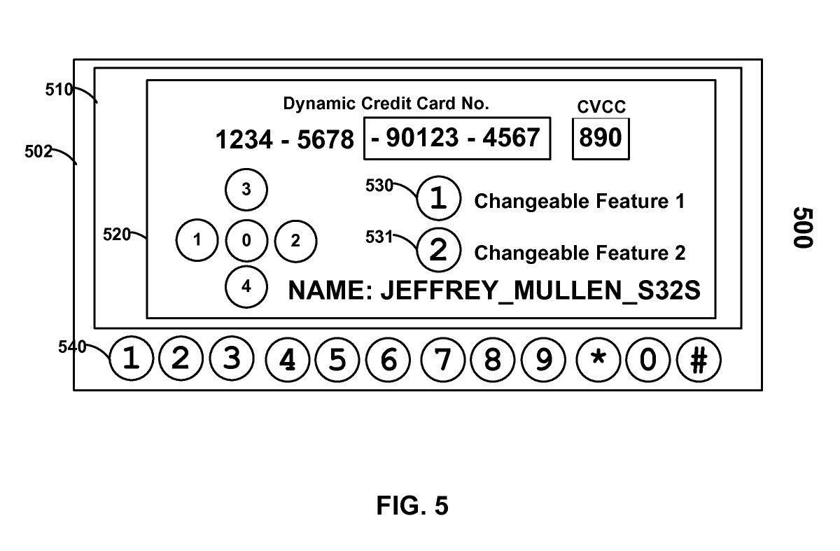

FIG. 5 shows device 500 that may include housing 502, display 510, virtual card 510, physical buttons 540, and virtual buttons 530 and 531. Device 500 may be, for example, a mobile telephonic device or other device (e.g., portable computer such as a portable tablet computer). Display 510 may be a touch-sensitive display. Person skilled in the art will appreciate that any physical card provided herein may be provided as a virtual card on a mobile telephonic device. Physical buttons may, for example, correspond to virtual buttons. Device 500 may communicate information to a card reader, for example, via a contactless (e.g., an RFID signal) or contact-based signal (e.g., a USB connection). For example, virtual button 530 may correspond to one feature form one third party service provider while virtual button 531 may correspond to another feature from another third party service provider. Persons skilled in the art will appreciate that the device provider may, for example, provide features. Additionally, for example, all features for a card may be utilized with a particular payment account (e.g., a credit account) such that a payment transaction with that payment account is performed if any feature is selected. As per another example, one or more features may be associated with a payment account (e.g., a credit account) while an additional one or more features may be associated with a different payment account (e.g., a debit account). Accordingly, a feature selected associated with a credit account may be utilized to purchase with credit and may perform an additional action associated with that feature and a different feature selected associated with a debit account may be utilized to purchase with debit and may perform an additional action associated with that different feature.

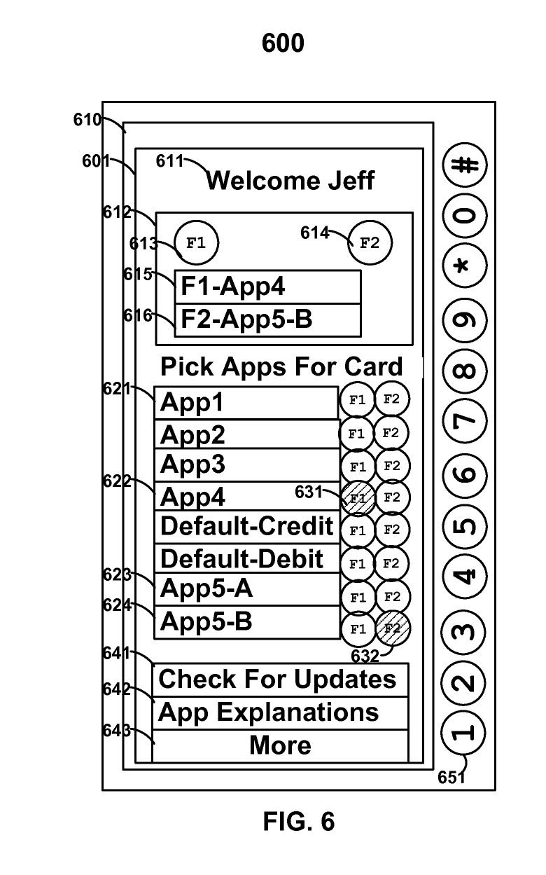

FIG. 6 shows device 600. Device 600 may include one or more physical buttons 651, display screen 610 (e.g., a touch display screen such as a capacitive-touch or resistive-touch display screen), GUI 601, test 611, virtual card 612, virtual indicia 613 and 614, field descriptors 615 and 616, application 621-624, selection options 631, 632, and 641-643.

A user may associated a card, such as a powered or non-powered card, with an application manager for managing third party service features. Such an application manager may be provided, for example, on a remote facility and displayed on a graphical user interface to allow a user to change the third party service features associated with a card. In this manner, a user may utilize a GUI to be provided with an ecosystem of applications and may, for example, select, at any time, a particular feature to associate with a card or a card button. Persons skilled in the art will appreciate that a default feature may be provided or that a number of features provided by a card issuer or entity may be provided in addition to third party service features. For example, a card issuer may provide a card with a default on one button for credit and a default for a second button as decoupled debit. A user may press the first button to perform a credit transaction. A user may press the other button to perform a decoupled debit transaction.

Virtual card 612 may be provided as a representation of a user's physical card associated with an application manager. A user may be provided with the ability to change between multiple physical cards and configure the features associated with those multiple physical cards. Accordingly, virtual card 612 may be provided with indicia 613 in the configuration of, and indicative of, one physical button associated with a user's physical card and virtual card 612 may be provided with indicia 614 in the configuration of, and indicative of, another physical button associated with a user's physical card. Fields 615 and 616 may include the features associated with each button. Accordingly, a user may, for example, view virtual card 612 in order to refresh the user's memory on the features associated with the physical buttons on a user's physical card (not shown). GUI 601 may be, for example, provided as an application for a device (e.g., a portable computing device or a mobile telephonic device) or retrieved information from a web browser. Test 611 may, for example, identify the user associated with virtual card 612 and the corresponding physical card (not shown).

A list of applications may be provided on a card. Such applications may provide features for a third party service provider. A user may, for example, select that different applications be associated with a particular card or a particular button on a card. For example, selection 631 may associate application 622 to the physical button of a card associated with virtual button 613. Selection 632 may associate application 624 to the physical button of a card associated with virtual button 614. In doing so, a user may change the features of a card by using GUI 601. A physical card (not shown) may communicate information indicative of the button that was pressed with other payment data (e.g., an account number, security code, and other data). For example, information indicative of the button that was pressed may be included in discretionary data of a payment message. A payment message may be, for example, one or more tracks of magnetic stripe data (e.g., communicated from a dynamic magnetic stripe communications device), an RFID message (e.g., an NFC message from an radio frequency antenna), or an exposed IC chip message (e.g., an EMV message) from an exposed IC chip. Such information may be passed to a card issuer or processor from a point-of-sale and any intermediary devices (e.g., a merchant acquirer processing server) and the information may be passed to a remote facility (e.g., a facility providing an application manager) such that the remote facility may determine the button that was pressed by a user. This remote facility may, in turn, retrieve information associated with the third party feature (or a feature of a card issuer, processor, application manager provider, or any entity) and forward information to that feature provider such that the feature may be performed. Additional Information may be returned to the entity that provided the information indicative of the button the user pressed. Persons skilled in the art will appreciate that if, for example, a non-powered card is utilized than information indicative that a purchase was made may be provided to an application manager provider such that the application manager provider can initiate the desired feature for the non-powered card. For non-powered cards, for example, features may be associated with different types of purchases such as, for example, one feature may be provided for a particular merchant type (e.g., a game feature for gas purchases) and another feature may be provided for a different merchant type (e.g., a reward feature for transportation purchases). Features may be associated with other characteristics of a purchase such as, for example, a purchase above a particular amount (e.g., at or above $100) or a purchase below a particular amount (e.g., below $100). Such additional feature selections may be provided, for example, for powered cards and devices.

GUI 601 may be provided, for example, on a card issuer's website such as, for example, on a bill statement web page. GUI 601 may be provided, for example, above the bill statement or to the right of the bill statement. Accordingly, for example, a user may utilize the application manager to manager application features when the user is logged into his/her account. Similarly, a third party service provider may utilize GUI 601 as part of a user's administration or experience of that third party service. Accordingly, for example, a user's profile page for a third party service may include GUI 601. In this manner, application manager provider may provide web-code that retrieves GUI 601 from a remote facility managed by the application manager provider. Selection 641 may be utilized by a user to check for updates (e.g., confirm that a feature was changed or if any updates are present). Selection 642 may be utilized to explain the functionality of a particular application feature. Selection 643 may be utilized for additional selection options.

A card may be provided with one button for a particular payment account (e.g., credit) and one button for a changeable feature. Accordingly, a user may, for example, only need to remember one feature associated with a card. A credit account may include rewards such as points, cashback, or miles, from the card issuer. Accordingly, pushing the payment account button may earn the user such rewards. Pushing the changeable feature button may, alternatively, for example, not earn the user such rewards and may instead initiate a changeable feature. In doing so, for example, the cost of providing a card may be reduced in that the cost of rewards for the card may be reduced. A feature may include, for example, a feature from the card issuer, such as the ability for a user to earn a particular amount of points (e.g., 100) for a particular dollar amount added to a purchase (e.g., $1).

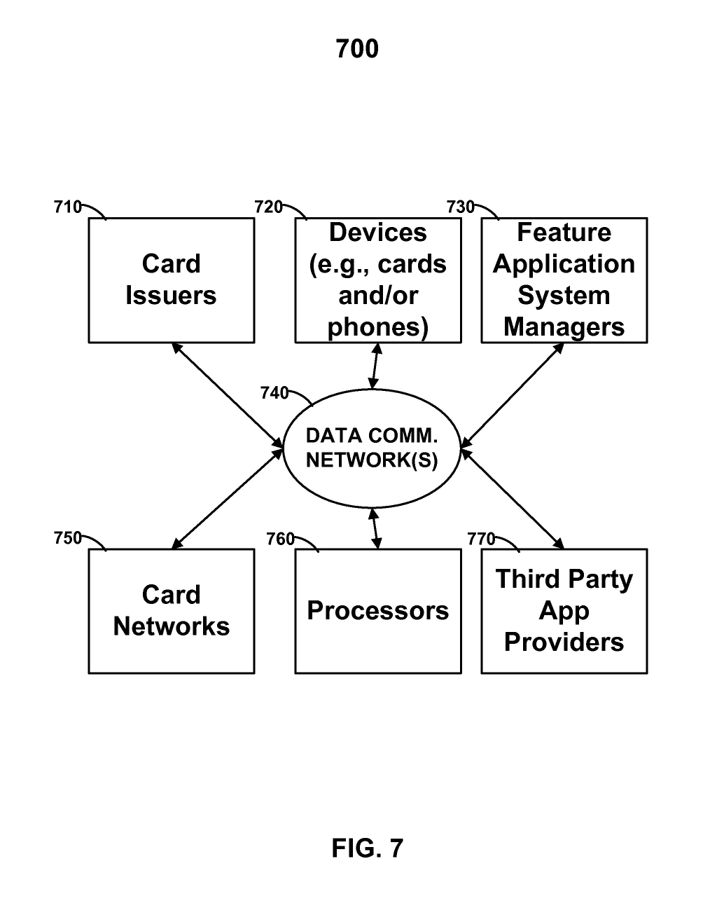

FIG. 7 shows network 700 that may include, for example, card issuer(s) 710, device(s) 720, feature application system manager(s) 730, data communications network(s) 740, card network(s) 750, processor(s) 760, and third party application provider(s) 770. Other entities may include resources in network 740. For example, merchant acquirer(s) and device provider(s) may provide resources in network 700. Feature application system manager(s) 730 may manage different identification numbers for a user and/or card for different entities and may exchange both information and value between the entities.

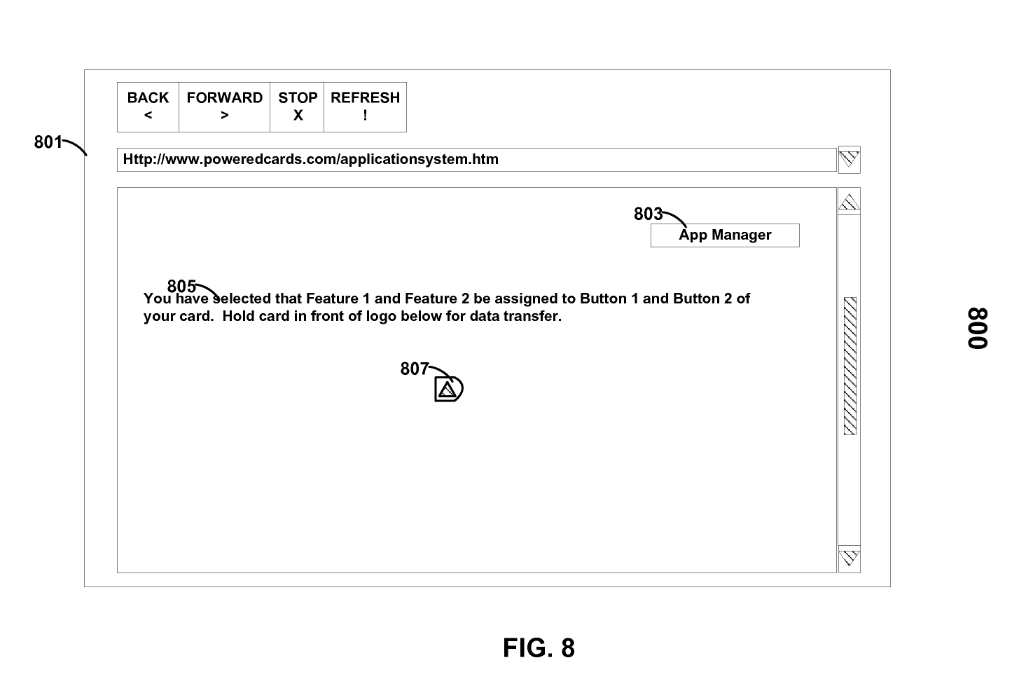

FIG. 8 shows graphical user interface 800. Graphical user interface 800 may be, for example, an internet browser display on a website or an application display on a device. A user may, using graphical user interface 800, select actions for a card and communicate corresponding configuration information to a card via, for example, light box 807. Light box 807 may communicate pulses of light indicative of configuration information to one or more light sensors on a card. A user's configuration, for example, may also be executed on the backend such that no information is communicated to the card to change the functionality of the card as a payment is processed. Accordingly, a user may select a feature or set of features for a card and may communicate such features to a card via light box 807. In doing so, for example, different information may be communicated from a card depending on the features loaded into a card for a particular button. Option 803 may be selected in order, for example, to provide a user with an application manager so the user can select applications for transfer to a card.

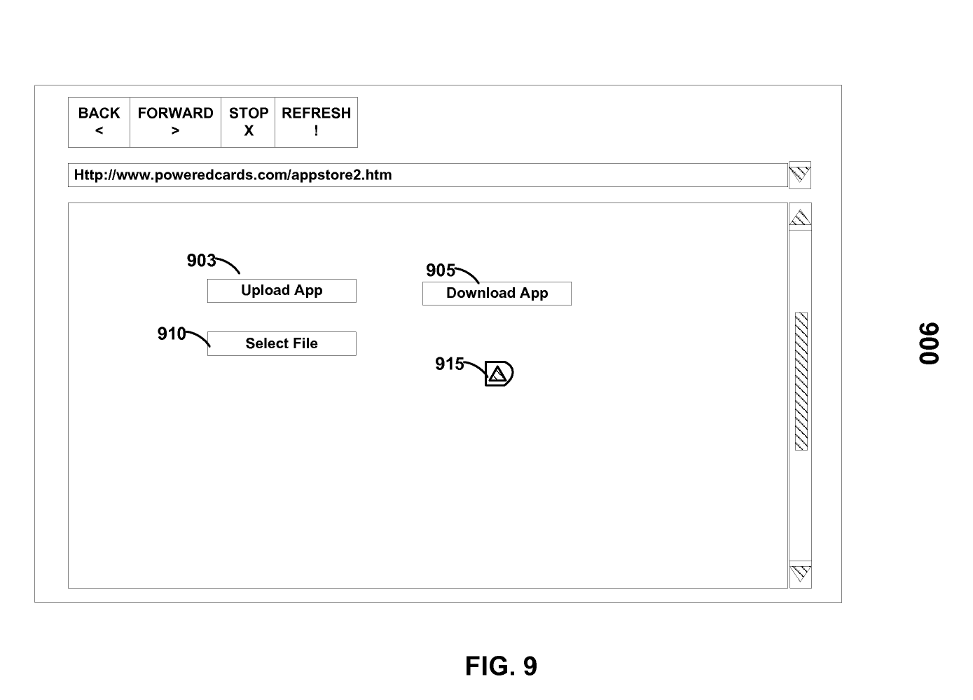

FIG. 9 shows graphical user interface 900. Application manager provider may provide a development kit for a third party service provider to use to develop applications. A developer may utilize option 910 to select an application file created using the development kit and upload the file to the application manager via option 903. Application manager may, for example, provide an approval process in which applications are approved or denied. A developer may be provided with a development card. An uploaded application may include information for the application manager. Option 905 may be utilized to download information from light box 915 to a development card. The developer may then test the developer's application on the card to confirm proper operation.

Persons skilled in the art will appreciate that a card may have any number of buttons. For example, a card may have four buttons, each associated with a feature in a different service (e.g., different online service) that may provide a user with a differentiating functionality in that service. Cards may be linked in groups. For example, groups of users that compete in a service together (e.g., a grandmother, grandson group) may earn awards for all users of that group. Accordingly, a grandmother making purchases may earn rewards or invoke service functionality for both herself and her grandson. Similarly, a grandson may utilize a payment card (or other card) to earn rewards or invoke service functionality for both himself and his grandmother. Additionally, linked cards may provide features for a selected user. For example, the grandmother's card may include a button for providing a feature to herself or to provide a feature for a particular user in her group (or the rest of the user's in her group). Accordingly, a user may decide who to provide the feature to at the point of sale. A feature gift provided to another user may, for example, be displayed on the service such that the receiving user is required to acknowledge receipt of the feature gift before using the feature gift.

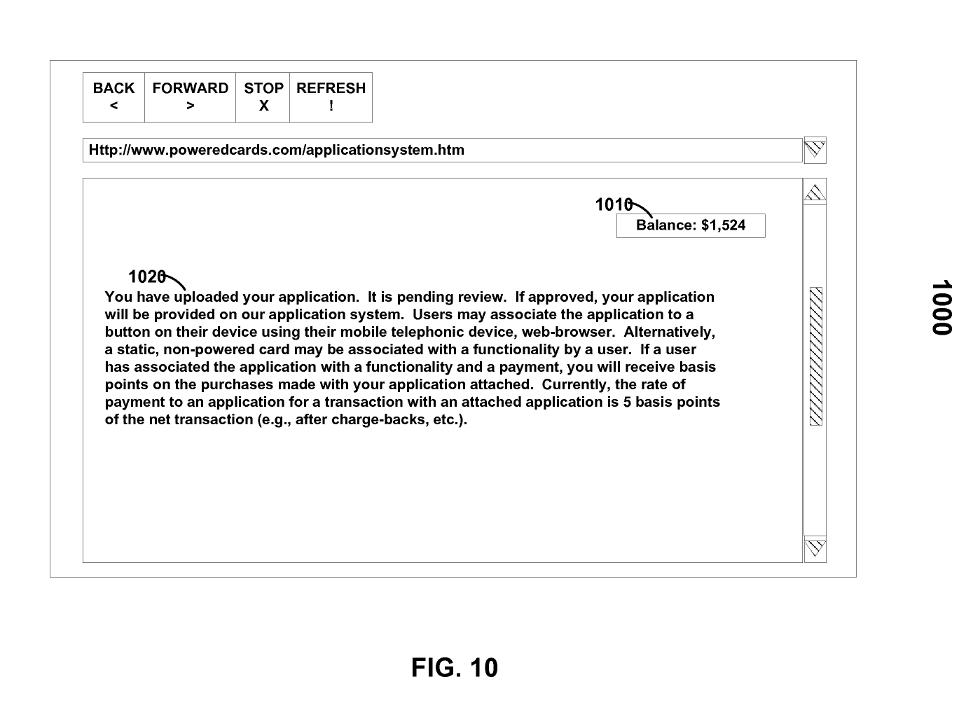

FIG. 10 shows GUI 1000 that may be provided with text 1020 and earned balance amount 1010. An application feature may earn an application developer (e.g., a third party developer) money. For example, a card provider or card issuer may provide a developer with a set fee every time the application is utilized, a percentage of a transaction in which the application is utilized, or a fixed or variable fee while an application is associated with a card or other device. Such a fee may be, for example, a fee of approximately 1-20 basis points for being utilized during a purchase and/or a fee of approximately 0.1-5 basis points for being associated with a card or other device that is utilized. An applications manager may, in turn, determine a user's desires at particular points of purchase or with particular cards or other devices. Value may be provided to the entity that provides an application manager. For example, a card issuer may provide the entity that provides the application manager with more value than the application manager distributes to application providers. In doing so, for example, the card issuer may be able to provide a user with a large library of third party service feature applications at the cost of the application manager from the entity that provides the application manager. Such a cost provided by a card issuer may be, for example, between approximately 5 and 100 basis points of a transaction (e.g., a credit transaction). Alternatively, for example, an application manager may be provided with a fixed fee for each transaction (or a combination of a fixed and variable fee).

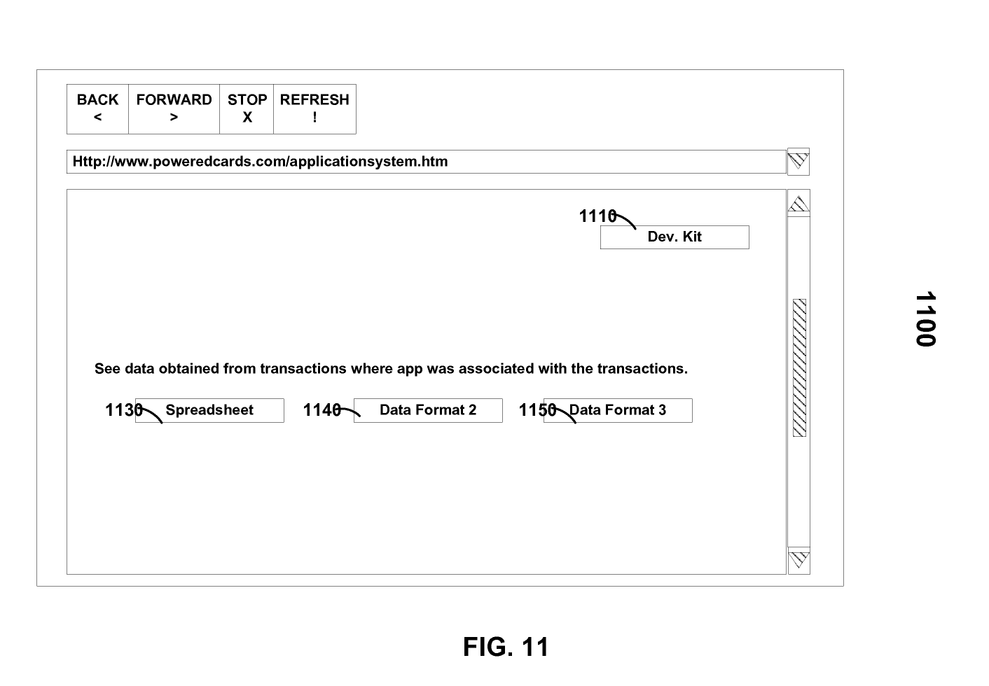

FIG. 11 shows GUI 1100 may be utilized by a application provider to obtain data from the transactions associated with that application provider's features. Option 1110 may be utilized to obtain a development kit. Option 1130 may be utilized to obtain the data in a spreadsheet format, option 1140 may be utilized to obtain the data in another format, and option 1150 may be utilized to obtain the data in yet another format.

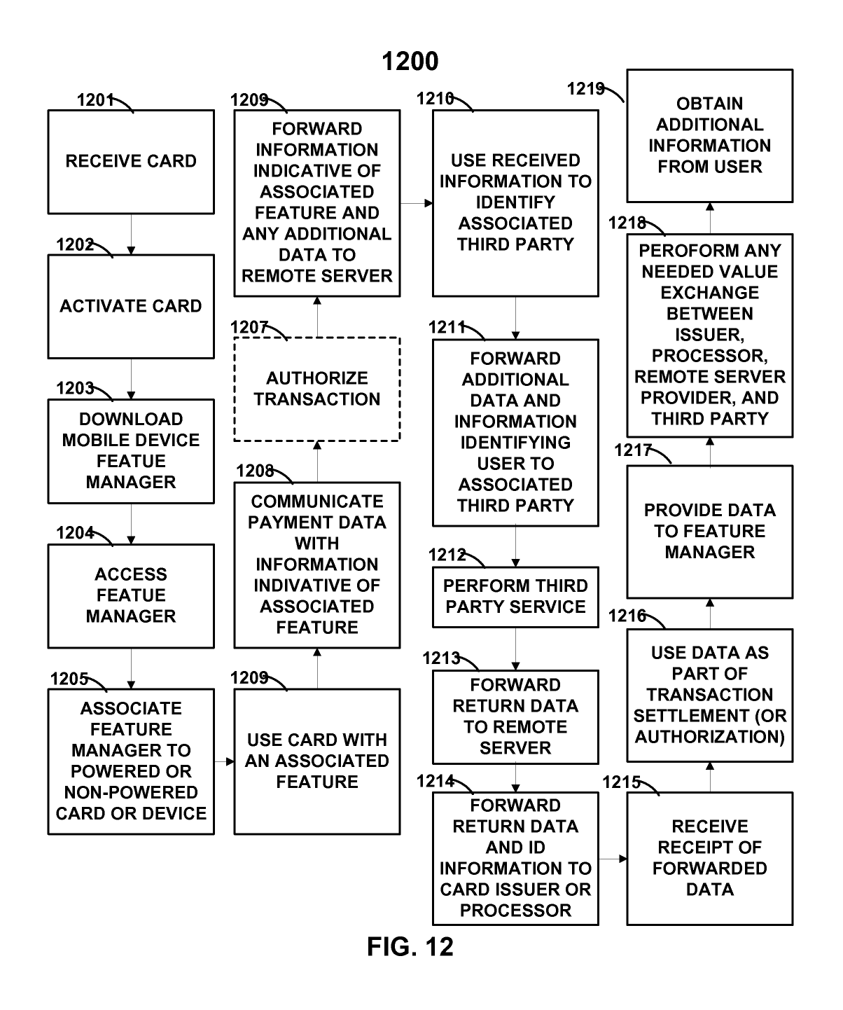

FIG. 12 shows process flow chart 1200. Step 1201 may be included in which, for example, a card is received by a user. Step 1202 may be included in which, for example, a card is activated by a user. A card, or other device, may be activated by, for example, calling a call-in center. Step 1203 may be provided in which, for example, a feature manager is downloaded to a mobile device or retrieved from a web browser (e.g., on a bill statement web-page). Persons skilled in the art will appreciate that steps in process flow chart 1200 may be provided in any order, steps may be removed, and steps may be added. Step 1204 may be provided, for example, in which a feature manager is accessed by a user. Step 1205 may be provided, for example, to associate a feature manager to one or more non-powered cards (e.g., a card with a static magnetic stripe or a card with a static magnetic stripe and an EMV chip or a card with a static magnetic stripe and an RFID, or any other non-powered card) or powered cards and devices. A powered card may be, for example, a battery-powered card. An association may occur, for example, by a user entering a user's payment card number into the feature manager as well as the expiration date and a security code provided on the back of the powered or non-powered card. A fee may be charged to the card that is associated, for example, with the feature manager. Such a fee may be a one-time fee or a periodic fee (e.g., an annual fee). Step 1209 may be provided, for example, in which a card is used with a feature from an application manager. Accordingly, for example, a user may associate a feature to a button of a card and use the card by pressing that button. Pressing that button may cause, for example, a transaction to be initiated on a payment account as well as initiate an additional feature previously selected on a feature manager. Payment information and information indicative of the associated feature (e.g., information associated with the selected button) may be communicated from a card to a card reader in step 1208. A transaction may be authorized, for example, in step 1207. Information indicative of the associated feature (e.g., the button that was pressed) may be communicated to a remote server (e.g., a server associated with the application manager) in step 1209. The remote server may, for example, retrieve the feature associated with the selected button, if selected button information is received, using the identity of the user received from step 1209. Step 1210, for example, may be utilized to identify the third party application feature. Step 1211 may be utilized, for example, to forward additional data and information identifying the user to the associated third party. For example, the identification information received in step 1209 may be forwarded to a third party service provider. Alternatively, for example, the identification information received in step 1209 may be changed to different identification information depending on, for example, the service provider that provides the feature. In doing so, for example, the remote server may synchronize different identification information from different third parties. In this manner, for example, the remote server may provide the ability for more than one service provider to provide a combined feature that may be associated to a card or button by a user. In this manner, multiple features may be utilized with a purchase transaction. Value provided to a service provider of a button may, in this manner, be split (e.g., evenly) between the combined service providers. The combined service providers may share information with one another through the remote server via the synchronization of identification numbers between the service providers. Step 1212 may be provided in which, for example, a third party service is performed. Return data from the third party service may be provided to the remote server in step 1213. Return data may be forwarded, as well as additional data such as identification information, may be provided back to a card issuer, processor, or other entity in step 1214. Step 1215 may be provided, for example, such that a remote server receives a receipt of forwarded data by the entity receiving the forwarded data. Step 1216 may be provided, for example, to use the forwarded data as part of a settlement transaction, authorization transaction, and/or post-settlement transaction (e.g., a post-statement credit). Step 1217 may be provided, for example, to provide data to feature manager as a result of step 1216. Step 1218 may be provided, for example, to perform any value exchange between the parties. Step 1219 may be provided, for example, to obtain additional information from a user. For example, a third party service provider may request additional information from a user (e.g., to rate a product the user purchased). Such information may then be retrieved from the user and forwarded to the third party service provider.

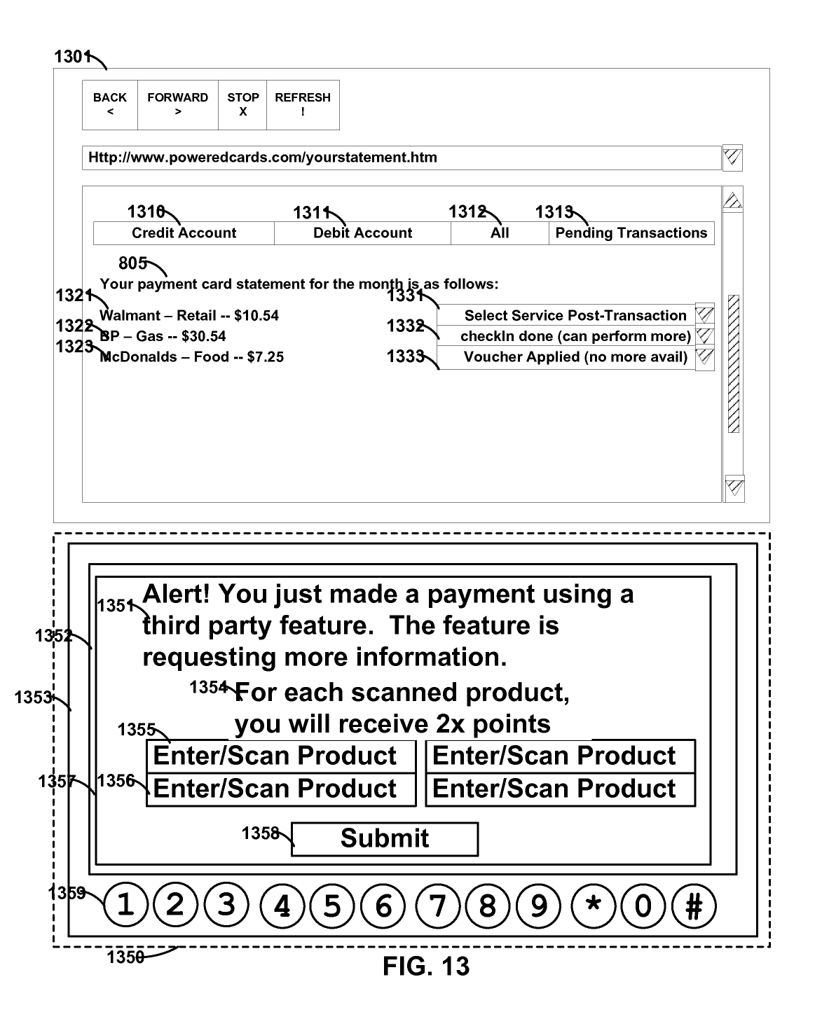

FIG. 13 shows GUI 1301 and device 1350. GUI 1301 may include, for example, a payment card statement or a statement of multiple payment card accounts. A user may switch between accounts using, for example, buttons 1310 and 1311. A user may see a consolidated bill of all accounts using, for example, button 1312. A user may see pending transactions that have not yet posted using option 1313. Information 805 may be provided and may include the time period of the statement. Transactions may be provided as transactional information 321-323. A user may be provided with the ability to, if permissible by the third party service provider, to perform additional features for the purchase or change the feature. If a feature was not selected for a purchase, the feature may be selected if permissible. An administrator may govern what is permissible based on the requirements of the parties involved. Option 1331 may be provided to permit a user to apply a feature after a transaction has been performed. Option 1332 may be provided to inform a user of the feature selected at the point of purchase and allow a user to add additional features. Option 1333 may be utilized to inform a user of the feature selected at the point of purchase and instruct the user that, for example, no more features may be performed.

FIG. 13 may include device 1350 that may include housing 1353, display 1352, GUI 1357, and physical button 1359. Alert 1351 may be provided to inform the user that a payment was made with a, or a particular, third party feature. Information 1354 may be utilized to request additional information from a user and notify the user of any incentives for providing additional information. Virtual buttons 1355 and 1356 may be utilized to enter additional information. For example, a user may be asked to scan the products purchased in order to receive the incentive. The third party service provider may check the price of each product to the total bill to confirm, for example, that all of the products were entered. If not, the application may request that additional products be scanned. Products may be scanned, for example, via a camera located on the device and program logic for discerning a barcode on the product and retrieving information from the barcode. Alternatively, for example, products may be manually typed in. Alternatively still, for example, the third party service provider may utilize the merchant name and location to provide a list of products sold by the store so that the user can select the products sold (e.g., the number of movie tickets and the particular movie a user saw). A user may submit this information by pressing, for example, virtual button 1358.

Persons skilled in the art will also appreciate that the present invention is not limited to only the embodiments described. Instead, the present invention more generally involves dynamic information. Persons skilled in the art will also appreciate that the apparatus of the present invention may be implemented in other ways then those described herein. All such modifications are within the scope of the present invention, which is limited only by the claims that follow.

What is claimed is:

1. A method comprising:
receiving manual input indicative of changing a feature associated with a payment device;
changing, on a remote server, said feature associated with said payment device;
receiving first information indicative of payment from said payment device;
authorizing payment for said payment device;
retrieving said feature from said remote server; and
providing second information, indicative of said authorized payment, to a third party service provider associated with said feature.

2. A method comprising:
receiving a new payment feature from a third party service provider;
approving said new payment feature for consumer release;
transferring, from a remote server, the ability for a payment device to receive manual input to select said approved new payment feature; and
utilizing said selected new payment feature as part of a purchase transaction.
